(19) United States
(12) Patent Application Publication
(10) Pub. No.: US 2023/0225407 A1
(43) Pub. Date: Jul. 20, 2023

(54) Evaporator

(71) Applicant: JT International SA, Geneva (CH)

(72) Inventors: Alec Wright, Guildford (GB); Andrew Robert John Rogan, Forres (GB); Kyle Adair, Lisburn (GB); Olayiwola Olamiposi Popoola, Walton-on-Thames (GB); Gordon Montgomery, Ballymena (GB)

(73) Assignee: JT International SA, Geneva (CH)

(21) Appl. No.: 18/007,122

(22) PCT Filed: Jul. 21, 2021
(86) PCT No.: PCT/EP2021/070340

§ 371 Date: Jan. 27, 2023

(30) Foreign Application Priority Data
Jul. 29, 2020 (EP) 20188464.0

(51) Int. Cl. A24F 40/46; H05B 3/14; A24F 40/10; A24F 40/48; B32B 9/00; B32B 3/26

(52) U.S. Cl. CPC A24F 40/46; H05B 3/148; A24F 40/10; A24F 40/48; B32B 9/005; B32B 3/266; H05B 2203/037; H05B 2203/007; B32B 2250/42; B32B 2307/202; B32B 2307/206; B32B 2307/20

(57) ABSTRACT

An evaporator for an aerosol generating device is described. The evaporator comprises a heating body (101) comprising a plurality of channels (102) arranged through the heating body between an inlet surface (103) and an outlet surface (104). The channels are configured to transport liquid from the inlet surface through the heating body by capillary action. The heating body comprises electrically conductive material (120) and the evaporator further comprises circuitry (116) for providing a current through the electrically conductive material to provide resistive heating of the heating body to evaporate a liquid passing through the channels. The heating body and circuitry are configured to provide a positive temperature gradient across the heating body from the inlet surface to the outlet surface.

### FIELD OF THE INVENTION

The present invention relates to vapour generation devices, and more specifically to evaporators for vapour generation devices.

### BACKGROUND TO THE INVENTION

Vapour generation devices such as electronic cigarettes have become popular as substitutes for traditional means of tobacco consumption such as cigarettes and cigars.

Evaporator devices for vaporisation or aerosolisation are known in the art. Such devices typically include a heating body arranged to heat a vaporisable product from an inlet surface to an outlet surface. In operation, the vaporisable product is heated and the constituents of the product are vaporised for the consumer to inhale. In some examples, the product may comprise tobacco in a capsule or may be similar to a traditional cigarette, in other examples the product may be a liquid, or liquid contents in a capsule.

Some vapour generation devices generate a vapour or aerosol from a vaporisable liquid. Different vapourisable liquids can have different properties (for example viscosity, density and volatility), which may be the result of the presence of different colourants, flavourings and other chemical components in the liquid. These different properties can affect the behaviour of the liquid under the conditions to which it is subjected in the vapour generation process, and this can affect the quality of the generated vapour, for example the size of the liquid droplets in the vapour, the temperature of the vapour and the overall rate at which the vapour is generated. To ensure an optimal user experience, it is desirable that the quality of the vapour generated by a vapour generation device is consistent between vapourisable liquids with different compositions and under different ambient conditions.

There is accordingly a need to improve the experience of the consumer of such products by improving the quality of the vapour flow. There is also a need to allow a greater range of liquid viscosities to be efficiently vapourised by the same aerosol generating device, providing users with a greater variety of e-liquids that are compatible with a single aerosol generating device. Another object of the invention is to address this.

### SUMMARY OF THE INVENTION

According to a first aspect there is provided an evaporator for an aerosol generating device comprising a heating body comprising a plurality of channels arranged through the heating body between an inlet surface and an outlet surface. The channels are configured to transport liquid from the inlet surface through the heating body by capillary action. The heating body comprises electrically conductive material and the evaporator further comprises circuitry for providing a current through the electrically conductive material to provide resistive heating of the heating body to evaporate a liquid passing through the channels. The heating body and circuitry are configured to provide a positive temperature gradient across the heating body from the inlet surface to the outlet surface.

When the evaporator is in use in an aerosol generating device, the e-liquid used in the device flows into the channel at the inlet surface as a liquid, and exits the channel at the outlet surface as a vapour. The positive temperature gradient from the inlet surface to the outlet surface causes the e-liquid to increase in temperature and decrease in viscosity as it flows through the channels. This causes the e-liquid to heat up and vapourise in a more controlled way compared to evaporators that expose e-liquids to a uniform temperature. Furthermore, as the e-liquids are exposed to a variety of temperatures, the evaporator can be used to effectively vapourise e-liquids with a range of viscosities as the viscosities are effectively normalised within the heating body to have the same viscosity for vaporisation. Thus, a wider variety of e-liquids are compatible with a single evaporator device, improving the choice of e-liquid product to consumers.

The temperature gradient also mitigates clogging problems associated with known aerosol generating devices, as any bubble generation occurs only close to the outlet of the channels and not throughout the entire channels. This improves the flow of e-liquids, reduces noise caused by bubble generation and increases longevity of the aerosol generating device.

The evaporator of the invention therefore provides an enhanced experience to users of aerosol generating devices as the flow of e-liquids through the device is smoother, the longevity of the device is improved, and there is a wider choice of e-liquids of different viscosities which are compatible with a single device.

The evaporator can be considered to comprise a heater which comprises the heating body and circuitry for providing a current through the heating body to provide resistive heating of the heating body. The electrically conductive material may be selected from metals, semiconductors, ceramics, conductive polymers and graphene based materials. Preferably, the electrically conductive material is silicon based. The circuitry may comprise a rechargeable battery as its power source. In some examples the evaporator may comprise an additional heater. In examples of the invention, the channels are arranged through the electrically conductive material to provide the required heating of the channels and evaporation of a liquid passing through the channel during use.

The heating body preferably comprises one or more layers of electrically conductive material arranged to provide the positive temperature gradient across the heating body. The layers are preferably planar sections of the heating body, wherein the planar sections are preferably parallel to the inlet and outlet surfaces. That is, the one or more layers are preferably perpendicular to the direction of the temperature gradient. For example, the heating body may comprise a layer of electrically conductive material at the outlet surface or the heating body may be fully constructed from electrically conductive material. In examples of the invention the channels pass through the one or more layers.

The evaporator may be arranged so as to preferentially heat the outlet surface, thereby providing the positive temperature gradient. Preferably, this is achieved by providing a resistive heating layer on the outlet surface. In other words, the heating body may comprise a layer of electrically conductive material at the outlet surface. Put another way, the heating body preferably comprises electrically conductive material arranged as a resistive heating layer at the outlet surface. When in use in an aerosol generating device, a current may be passed through the resistive heating layer, causing it to heat to a higher temperature than the rest of the heating body. As a result, the end of the heating body comprising the inlet surface is cooler than the end of the heating body comprising the outlet surface, aiding in the smoother flow of e-liquid as it travels through the channels of the heating body from the inlet to the outlet and vapourises. In some examples, a resistive heating layer, for example a metal, semiconductor or ceramic heating layer, is deposited directly on the outlet surface of the evaporator. The resistive heating layer may be a doped silicon layer.

In some cases, the heating body comprises a plurality of heating layers arranged sequentially between the inlet surface and the outlet surface, and the evaporator is configured such that the heating layers are heated to different temperatures to provide the temperature gradient. In particular, the heating layers and/or the circuitry may be configured such that the heating layers are heated to different temperatures during use. For example, the heating layers may comprise layers with different resistivity. The heating layers may comprise layers of a ceramic or semiconductor with differing dopant concentration, providing the different values of resistivity. In this way the layers are heated to different temperatures when a current is passed through the layers. Preferably the heating layers comprise semiconductor material where the dopant concentration differs between layers. In a particularly preferable example the heating body comprises a semiconductor material, such as silicon, wherein the heating body comprises layers of differing dopant concentration or a dopant concentration gradient, such that resistivity varies across the heating body.

When this multi-heating layer arrangement is adopted, further layers of insulation may be positioned between two neighbouring heating layers. This reduces the heat that transfers between heating layers of the heating body, aiding in the maintenance of the temperature gradient. In some cases, a layer of insulation may be provided between at least one pair neighbouring heating layers, forming a sandwich structure. Alternatively, a layer of insulation may be provided between each pair of neighbouring heating layers.

In cases where a multi-heating layer arrangement is adopted with layers of insulation in between two heating layers, the evaporator may be configured to pass a separate current through heating layer. In particular, the circuitry may be configured to pass separate currents through respective separate layers. This set-up enables the evaporator to adopt a variety of different temperature profiles through the thickness of the heating body as some heating layers may be turned on or off as desired. Consequently, the steepness of the temperature gradient may be optimised to effectively vapourise different e-liquids. In some cases, the temperature profile may be selected by the user of the aerosol generating device to suit a specific vapour generating product.

Preferably, the resistivity of the heating body varies across the heating body to provide the temperature gradient. In particular, preferably the resistivity of the heating body increases across the thickness of the heating body from the inlet surface to the outlet surface to provide the temperature gradient when a current is provided to the heating body. In cases where the evaporator comprises a plurality of heating layers, at least two of the plurality of heating layers may have a different resistivity. In some cases, each heating layer has a different resistivity.

Preferred electrically conductive materials for the heating body include semiconductors, particularly silicon, and ceramics that preferably have the dopant concentration configured to provide the positive temperature gradient when a current is provided to the heating body. In layered arrangements, this may be achieved by the heating body having a layer of increased dopant concentration at the outlet surface.

The average diameter of the channels is preferably between 5 μm and 200 μm, preferably between 10 μm and 190 μm, preferably between 50 μm and 150 μm, preferably between 70 μm and 130 μm. This diameter is sufficiently narrow to allow liquid to be drawn through the channels by capillary action. The diameter of the channels may be maintained throughout the length of the channels going through the thickness of the heating body. Alternatively, the diameter of the channels may change through the thickness of the heating body.

The diameter of the channels of the heating body may decrease in the direction between the inlet surface and the outlet surface. That is, in some cases the diameter of the opening of the channels at the inlet surface may be larger than the diameter of the corresponding openings at the outlet surface. During use in an aerosol generating device, any vapour generated in the evaporator is forced to pass through a narrower channel opening at the outlet surface, and as a result, a more powerful stream of vapour is released from the evaporator device. The diameter of each of the channels may decrease at the same degree or at different degrees across the thickness of the heating body.

Preferably, the evaporator is configured such that a liquid passing through the channels evaporates closer to the outlet surface than the inlet surface. This minimises clogging of the evaporator device, as any bubbles are formed only close to the outlet surface.

The evaporator is preferably configured to provide a temperature at the inlet surface of the heating body of 40° C. or more, preferably 45° C. or more, preferably 50° C. or more. Exposure to such temperatures at the inlet surface typically causes e-liquids to reduce in viscosity, aiding in the uptake of the liquid through the channels by capillary action.

The evaporator is preferably configured to provide a temperature at the outlet surface of the heating body of between 200° C. and 350° C., preferably between 240° C. and 300° C., preferably between 250° C. and 270° C. These temperatures are sufficient to effectively vapourise most, if not all, e-liquid products. The temperature at the outlet surface should exceed the temperature at the inlet surface, in order to maintain the temperature gradient.

The evaporator may comprise a liquid store in fluid communication with the inlet surface of the heating body such that liquid is drawn from the liquid store through the heating body during use. The liquid store can hold e-liquid formulations, which may comprise colourants, flavourings, tobacco and other chemical components in the liquid. The evaporator assembly may comprise a wick positioned between the liquid store and the inlet surface of the heating body that may be formed of a material capable of continually absorbing liquid from the liquid store towards the inlet surface. It therefore aids in maintaining the fluid communication of the liquid in the liquid store with the inlet surface of the heating body, contributing to the smooth flow of e-liquid through an aerosol generating device when a user inhales from the device.

There may be provided an aerosol generating device comprising the evaporator device, and any of its modifications, as described herein. In some examples, the aerosol generating device may comprise a liquid store arranged such that it is in fluid communication with the inlet surface, so that liquid is drawn from the liquid store through the plurality of channels during use. In some examples, the liquid store may be provided as a component of a removable capsule wherein the aerosol generating device is configured to receive the capsule such that it is in fluid communication with the evaporator. In other examples, the evaporator may be a component of the removable capsule.

In another aspect of the invention, there is provided an evaporator for an aerosol generating device comprising: a heating body comprising a plurality of channels arranged through the heating body between an inlet surface and an outlet surface, the channels configured to transport liquid from the inlet surface through the heating body by capillary action; a heater for heating the heating body to evaporate a liquid passing through the channels; wherein the heater is configured to provide a positive temperature gradient across the heating body from the inlet surface to the outlet surface. All of the features described herein and set out in the appended claims may equally be applied to evaporators according to this aspect. In particular in these examples, the heater may be considered to comprise electrically conductive material of the heating body and circuitry for providing a current through the heating body to provide resistive heating.

### BRIEF DESCRIPTION OF THE DRAWINGS

An example of an evaporator assembly and vapour generation device in accordance with the invention will now be described with reference to the accompanying drawings, in which:

FIG. 1a is an perspective view of an embodiment of an evaporator assembly in accordance with the invention. FIG. 1b is a cross-sectional view of this same assembly.

FIG. 2 is a perspective view of an exemplary evaporator assembly of the invention comprising a resistive heating layer at the outlet surface.

FIG. 3 is an exemplary evaporator assembly of the invention comprising a plurality of heating layers arranged sequentially between the inlet surface and outlet surface.

FIG. 4 is an exemplary evaporator assembly of the invention comprising a plurality of heating layers and further comprising layers of insulation between each pair of neighbouring heating layers.

FIG. 5 is an exemplary evaporator assembly of the invention wherein the heating body comprises an electrically conductive material and the heater comprises the heating body and circuitry.

FIG. 6 is a cross-sectional view of an exemplary evaporator assembly comprising channels having a decreasing diameter in a direction between the inlet surface and the outlet surface.

FIG. 7 is an evaporator assembly according to the invention further comprising a liquid store.

FIG. 8 shows schematically an embodiment of an aerosol generating device comprising the evaporator of the invention.

### DETAILED DESCRIPTION

An aerosol or vapour generating device is a device arranged to heat a vapour generating product to produce a vapour for inhalation by a consumer. In a specific example, a vapour generating product can be a liquid which forms a vapour when heated by the vapour generation device. A vapour generating device can also be referred to as an electronic cigarette or aerosol generation device. In the context of the present disclosure, the terms vapour and aerosol can be used interchangeably. A vapour generating product, or aerosol generating product, can be a liquid or a solid such as a fibrous material, or a combination thereof, that when heated generates a vapour or aerosol. The vapour generating product may also be referred to as an e-liquid.

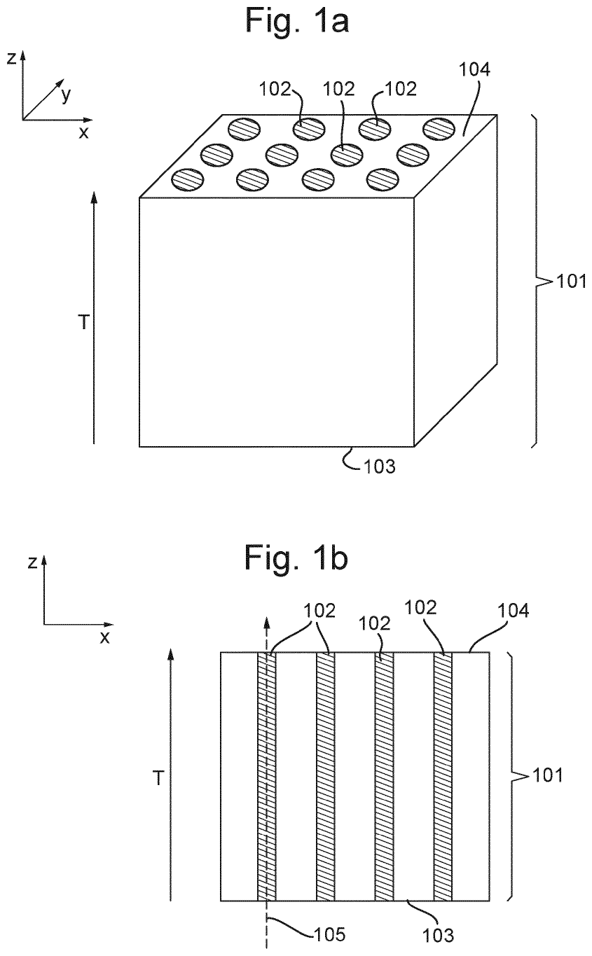

FIGS. 1a and 1b are perspective and cross-sectional views of an embodiment of an evaporator assembly in accordance with the invention. The evaporator comprises a heating body 101 with a plurality of channels 102 arranged through the heating body 101 between an inlet surface 103 and an outlet surface 104. In this example, the plurality of channels 102 is sufficiently narrow (i.e. has a sufficiently small cross-sectional area in the x-y plane) that when it receives a vapourisable liquid, the vapourisable liquid can travel along the channels from the inlet surface 103 to the outlet surface 104 by capillary action. The dashed arrow 105 illustrates the direction of the flow of vapourisable liquid.

The evaporators of the invention provide resistive heating of the heating body to evaporate a liquid passing through the channels when in use. In particular the heating body comprises electrically conductive material which is heatable by resistive heating by passing a current through the heating body. Therefore the evaporator can be considered to include a heater comprising the heating body 101, either entirely or partially. When the heating body 101 is heated by passing a current through the electrically conductive material of the heating body, a positive temperature gradient is generated across the heating body 101 from the inlet surface to the outlet surface 104. When the evaporator is in use in an aerosol generating device, this temperature gradient causes the e-liquid to change viscosity as it rises through the channels 102 from the inlet surface 103 to the outlet surface 104. Changing the temperature through the channels 102 affects the rate at which the vapourisable liquid heats up as it passes through the channels 102. As an e-liquid is exposed to increasing temperature as it passes through the channels 102, it heats in a more controlled way compared to evaporators that expose e-liquids to a uniform temperature. As a result, e-liquids with a range of viscosities can be used as the viscosities are effectively normalised.

At the inlet surface 103, e-liquids of a range of viscosities can be taken up into the channels 102 of the heating body 101, however, when these e-liquids of variable viscosities reach the outlet surface 104, they are normalised to have effectively the same viscosity for evaporation. This improves the choice of compatible e-liquids to users of the device and improves the flow of the e-liquids, providing an enhanced user experience.

The temperature gradient also mitigates clogging problems associated with known aerosol generating devices. In the present invention, the temperature increase of the e-liquid is better controlled as it passes through the channels, and any bubble generation occurs only close to the outlet of the channels and not throughout the entire channels. This provides improved flow of e-liquids, reduced noise caused by bubble generation and increased longevity of the aerosol generating device.

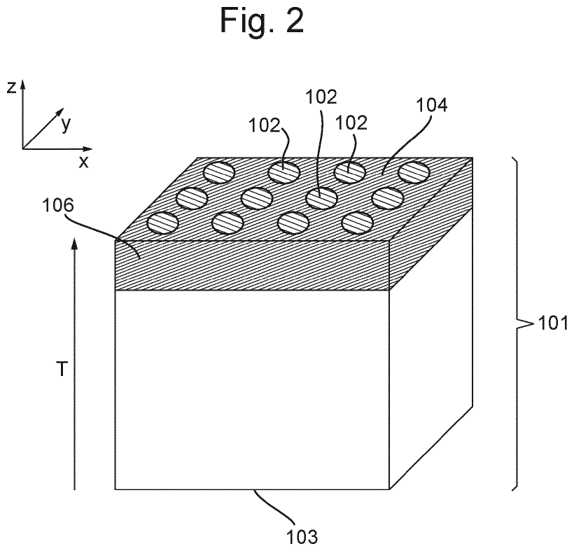

FIG. 2 shows the structure of an evaporator assembly suitable for use in embodiments of the invention. A plurality of channels 102 extends through the heating body 101 between an inlet surface 103 and an outlet surface 104. In this example, the evaporator comprises a resistive heating layer 106 on the outlet surface 104. The resistive heating layer 106 is arranged to preferentially heat the outlet surface 104 of the heating body 101 when in use, thereby providing a positive temperature gradient from the inlet surface 103 to the outlet surface 104.

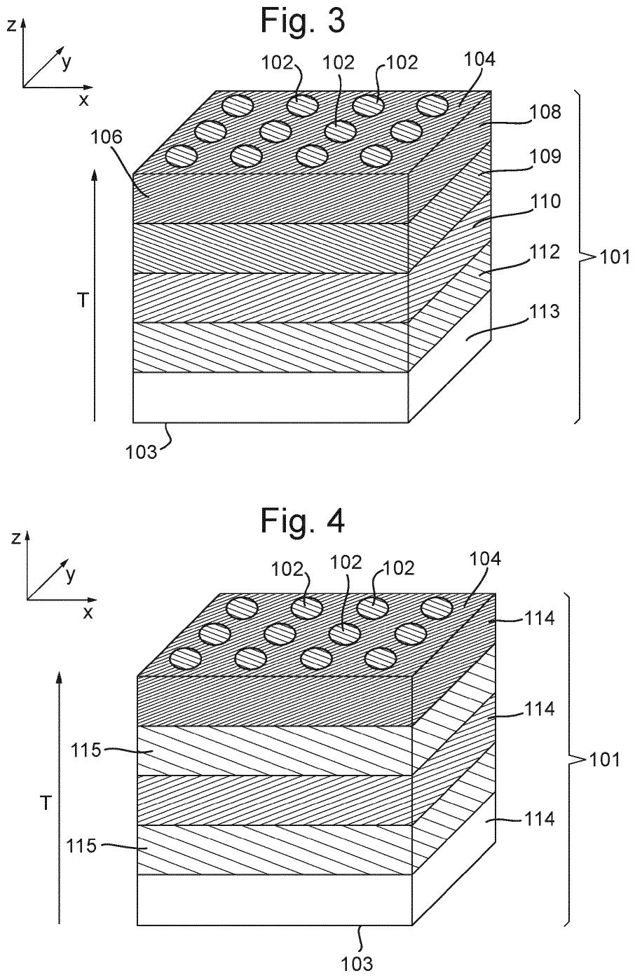

FIG. 3 is an exemplary evaporator assembly suitable for use in embodiments of the invention. In this example, a plurality of heating layers 108-113 are arranged sequentially between the inlet surface 103 and outlet surface 104 of the heating body. Like in the examples discussed above, a plurality of channels 102 extend through the heating body 101 in the z direction. The heating body is arranged to heat the heating layers 108-113 to different temperatures to provide a temperature gradient.

FIG. 4 is an exemplary evaporator assembly of the invention comprising a plurality of heating layers 114 and further comprising layers of insulation 115 between two heating layers 114. The heating layers 114 preferably have different temperatures. The layers of insulation 115 reduce the transfer of thermal and/or electrical energy through the heating body 101. This reduces the heat that transfers from the heating layers 114 positioned closer to the outlet surface 104 that have a higher temperature than the heating layers 114 positioned closer to the inlet surface 103. As a result, the temperature gradient is effectively maintained.

The layers of insulation 115 also enable a separate current to be applied to each heating layer 114, as electrons will not freely flow through the insulator layers 115 separating each heating layer 114. This set-up enables the evaporator to adopt a variety of different temperature profiles through the thickness of the heating body 101, as some heating layers 115 may be turned on or off as desired. Consequently, the steepness of the temperature gradient may be optimised to vapourise a variety of e-liquids.

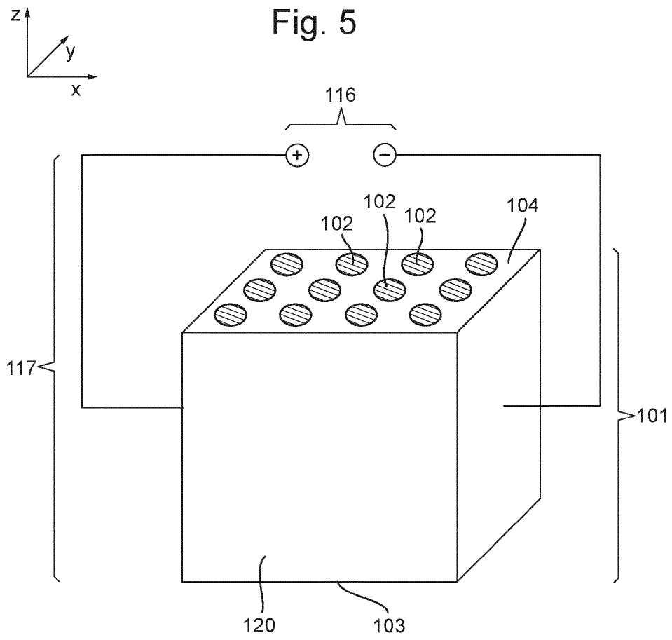

FIG. 5 is an exemplary evaporator assembly suitable for use in embodiments of the invention wherein the heating body 101 comprises an electrically conductive material 120 and circuitry 116 for providing a current through the heating body. The electrically conductive material may be selected from metals, semiconductors, ceramics, conductive polymers and graphene based materials. Preferably, the electrically conductive material is silicon based. The circuitry may comprise a rechargeable battery as its power source. In preferred embodiments, the resistivity of the heating body 101 increases across the thickness of the heating body 101 in the direction from the inlet surface 103 to the outlet surface 104. The increased resistivity causes an increased temperature when a current is passed through the heating body, aiding in the formation of the required temperature gradient of the invention. In some embodiments, this may be achieved by the heating body having a plurality of heating layers, wherein at least two of the plurality of heating layers have a different resistivity. In some embodiments, each heating layer may have a different resistivity. In other examples, a resistivity gradient may be provided across the heating body.

In preferred embodiments, the heating body comprises a semiconductor or ceramic, wherein the dopant concentration is configured to provide a positive temperature gradient when a current is provided to the heating body. The doped semiconductor or ceramic may be a predominantly negative (n-type) charge carrier, with electrons being the majority carriers. Alternatively, the doped semiconductor or ceramic may be a predominantly positive (p-type) charge carrier, with positive holes being the majority carrier. Preferably, there is increased dopant concentration at the outlet surface, providing increased resistivity of the heating body in the z direction. This results in an increased temperature when a current is passed through the heating body, thereby forming the required temperature gradient.

As shown in previous examples, the heating body may comprise stacked heating layers arranged sequentially between the inlet surface and the outlet surface, and may optionally comprise one or more layers of insulation between the heating layers. The heating layers may be formed of an electrically conductive material. When the evaporator assembly comprises a circuitry and layers of insulation separating two heating layers comprising electrically conductive materials, each heating layer may be individually connected to the circuitry to enable the flow of electrons to these materials for heat generation.

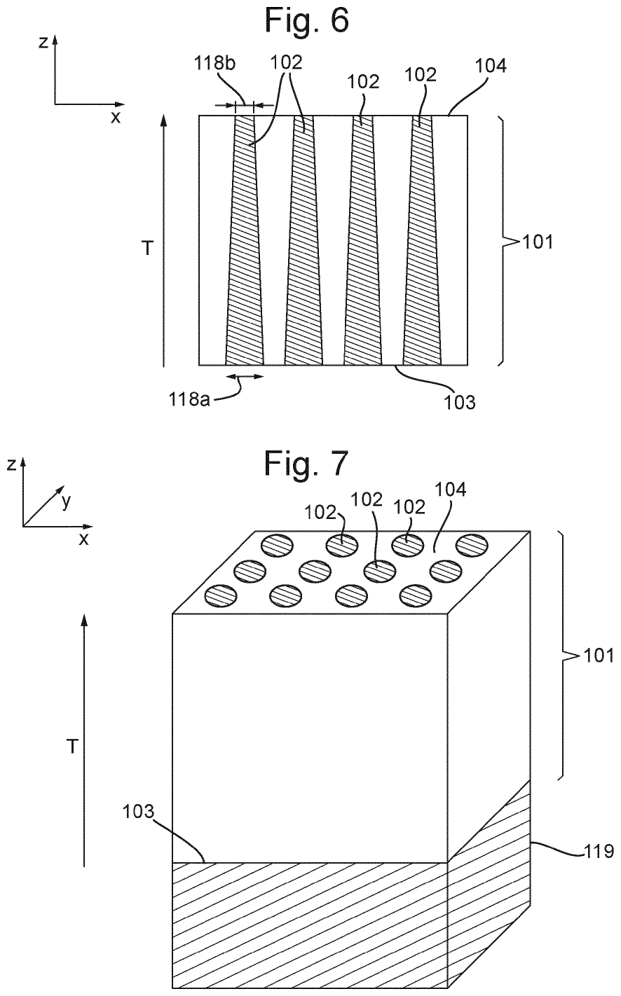

FIG. 6 is a cross-sectional view of an exemplary evaporator assembly according to the invention comprising channels 102 having a decreasing diameter in a direction from the inlet surface 103 to the outlet surface 104. This results in the opening to the channels 102 at the inlet surface 103 having a wider diameter 118a than the corresponding opening to the channels 102 at the outlet surface 104, which have a narrower diameter 118b. During use in an aerosol generating device, e-liquid flows through the channels 102 from the wider opening of the channel 118a at the inlet surface 103, vapourises within the channel upon exposure to an increasing temperature across the thickness of the heating body 101, and exits in vapour state through the channel through the narrower opening 118b at the outlet surface 104. As the vapour is forced to pass through a narrower channel opening 118b, a more powerful stream of vapour is released from the evaporator device. This results in stronger flow of vapour through the aerosol generation device when a user inhales from the device.

FIG. 7 is an evaporator assembly according to the invention further comprising a liquid store 119 in fluid communication with the inlet surface 103 of the heating body 101. The liquid store can hold e-liquid formulations, which may comprise colourants, flavourings, tobacco and other chemical components in the liquid. When in use, the liquid is drawn from the liquid store 119 through channels 102 of the heating body 101. The evaporator assembly may comprise a wick positioned between the liquid store 119 and the inlet surface 103 of the heating body 101. The wick may be formed of a material capable of continually absorbing liquid from the liquid store towards the inlet surface 103. Such materials may be porous. The wick therefore aids in maintaining the fluid communication of the liquid in the liquid store 119 with the inlet surface 103 of the heating body 101.

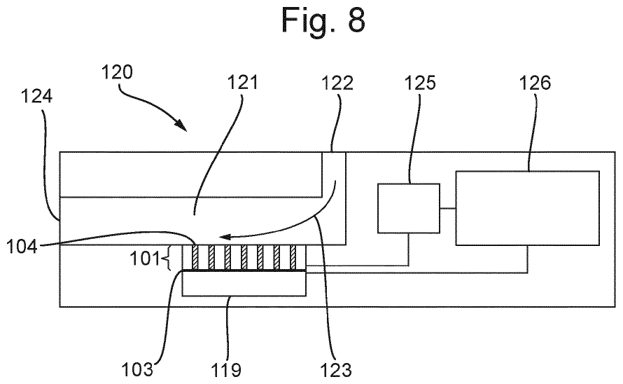

FIG. 8 shows schematically an aerosol generating device 120 comprising the evaporator 100 of the invention with a positive temperature gradient through the thickness of the heating body 101 from the inlet surface 103 to the outlet surface 104. An airflow channel 121 extends through the aerosol generating device 120, and the evaporator assembly 100 described above is arranged such that the outlet surface 104 is exposed to the interior of the airflow channel 121. The evaporator assembly 100 receives a vapourisable liquid from a liquid store 119. Air can be drawn into the airflow channel 121 through an inlet 122 and travel through the airflow channel along the direction indicated by the arrow 123. As the air passes the outlet surface 104 of the evaporator assembly, droplets of the vapourisable liquid are drawn away from the outlet surface 104 by the airflow. This produces a vapour of the vapourisable liquid. The vapour continues to travel along the airflow channel 121 and exits the vapour generation device via an outlet 124. The outlet may be provided with a mouthpiece, allowing the airflow to be generated by a user drawing on the device 120 at the mouthpiece.

In this example, the evaporator 100 is in communication with an electronic controller 125. Indeed, the electronic controller 125 could incorporate one or more control circuits that may be connected so as to provide a controlled current to provide the resistive heating of the heating body. If the evaporator comprises multiple heating layers, separate control circuits may be connected to each heating layer. The electronic controller 125 can also be configured to control other components of the aerosol generating device 120. The aerosol generating device 120 also has a power source, for example a rechargeable battery 126. The power source is configured to supply power to the components of the evaporator assembly 101 and the electronic controller 125, and can also power other components of the vapour generation device 120, for example valves and reheaters in the airflow channel or lights for displaying information about the operation of the device 120. In preferred embodiments, the temperature gradient is configured such that a liquid passing through the channels evaporates closer to the outlet surface than the inlet surface. When in use in an aerosol generating device, the e-liquid will enter the channel openings at the inlet surface and travel over half way through the thickness of the heating body through the channels as a liquid before it reaches the temperature required for evaporation. Following evaporation, it will exit the evaporator through the outlet as a vapour. This feature minimises bubble generation throughout the channels, as any bubble generation occurs only close to the outlet of the channels and not closer to the inlet of the channels. In turn, this provides improved flow of e-liquids, reduced noise caused by bubble generation and increased longevity of the aerosol generating device due to minimised clogging.

E-liquids typically used in aerosol generating devices undergo a significant drop in viscosity upon heating. For example, an increase in temperature from 20° C. to 40° C. can cause a drop in viscosity of more than 50%. This aids in improved uptake of liquid through the channels by capillary action. Therefore, in preferred embodiments of the invention, the evaporator (i.e. the heating body and circuitry) is configured to provide a temperature at the inlet surface of 40° C. or more, preferably 45° C. or more, preferably 50° C. or more.

The evaporator is preferably configured to provide a temperature at the outlet surface. In order to undergo vapourisation, e-liquids typically require a temperature of 200-350° C. Therefore, preferably the e-liquid is exposed to a temperature between 240° C. and 300° C. at the outlet surface of the heating body, most preferably between 250° C. and 270° C. The temperature at the outlet surface must exceed that at the inlet surface in order for the required temperature gradient to be established.

The channels of the heating body preferably have a diameter between 5 μm and 200 μm, preferably between 10 μm and 190 μm, preferably between 50 μm and 150 μm, preferably between 70 μm and 130 μm. Diameters of this width have a sufficiently small cross-sectional area in the x-y plane that when it receives a vapourisable liquid when in use, the vapourisable liquid can travel along the channels from the inlet surface to the outlet surface by capillary action. The ability of the channels to transport liquid through capillary action may depend on both the viscosity of the liquid and the dimensions of the channels. The channels of the evaporator may each have the same diameter, or they may have different diameters to accommodate a wider range of e-liquid viscosities.

As outlined above, the diameter of the channels may decrease in the direction from the inlet surface to the outlet surface. In embodiments, the diameter of each of the channels decreases at the same degree across the thickness of the heating body. In alternative embodiments, the diameter of the channels may decrease at different degrees across the thickness of the heating body.

It is understood that a variety of arrangements of channels may be utilised. For example, the channels may be spaced in a regular array. This helps achieve a uniform rate of liquid transport through the channels. The array could be defined by a cellular structure, for example, in a honeycomb, grid or triangular structure. In some embodiments the channels may be arranged in parallel or off-set rows. The openings of the channels on the inlet surface and the outlet surface may adopt a variety of shapes, for example, circular, square, rectangular or hexagonal. Consequently, the cross-sectional shape of the channels in the x-y plane throughout the heating body may also adopt a variety of shapes.

The surface tension of the liquid allows the liquid to rise, or flow, through each channel via capillary action. Vapourisation of the liquid within the channel occurs when the liquid has travelled sufficiently far along the length of the channel and reaches the temperature required for vaporise.

The height that the liquid will rise to within a channel under capillary action is given by the following relationship:

$$h = \frac{2 γ cos θ}{ρ g r} , \qquad Eq . 1$$

where γ is the liquid-air surface tension (force/unit length), θ is the contact angle, ρ is the density of the liquid (mass/volume), g is the local acceleration due to gravity (length/square of time), and r is the radius of the channel. Thus, the thinner the channel in which the liquid can travel, the further up the channel it travels.

Different vapor-generating liquids typically have different surface tensions, contact angles, and density values and so, in accordance with Eq. 1 above, will rise to different heights within a given channel. Selective passage of liquids through the channels can therefore be achieved by making the channel height greater or less than an effective height for vaporization, for a given radius of channel. This selection effect can also be achieved by adjusting the radius of the channel for a given height. Thus, in the case of the present disclosure, variations in channel size provide the selective passage of liquids through the heating body.

Thus, having a heating body comprising a plurality of channels of different diameters means that a particular channel diameter can be used to selectively pass a liquid of specific properties through the channels. This can be achieved by optimally sizing each channel for use with a particular liquid type. The evaporator unit can therefore be thought of as a universal evaporator unit.

Advantageously, the different channel sizes allow a greater range of liquids to be vaporised by the same evaporator. This results in a more efficient evaporator because it is able to function with a greater range of liquids that can be stored in in the device. That is to say, one evaporator unit can be used with multiple different liquids. The channels having different channel diameters distributed across a single heating body therefore increases the versatility of the evaporator.

A further advantage of the evaporator unit is that the presence of the larger diameter channels also has the effect of reduced resistance-to-flow of the liquid, which allows for a sufficient amount of liquid supply (mainly through the larger channels) even when the heating body temperature is still low and the liquid viscosity remains high (i.e. at an initial stage of heater operation). It is understood that a higher viscosity liquid receives a greater friction force as it travels through the through-channels. This means that movement of the high viscosity liquid tends to be slow until it is heated up and its viscosity is reduced, resulting in limited amounts of liquid supply for vapourization at an initial stage of heater operation. However the combination of the large and small through-channels contributes to suitable amounts of liquid supply especially for the high viscosity liquid, throughout the heater unit operation period i.e. both at initial and later stages.

The inventors have found that alteration in both the temperature profile and the channel diameter across the thickness of the heating body allows the flow of the e-liquid to be better controlled, and liquids of different viscosities can be used in the same evaporator device as their viscosities are effectively normalised as they pass through the channels from the inlet surface to the outlet surface across a positive temperature gradient. As a result, consumers have greater versatility with a single device, as it provides compatibility with greater range of e-liquid products of different viscosities.

1. An evaporator for an aerosol generating device comprising:
a heating body comprising a plurality of channels arranged through the heating body between an inlet surface and an outlet surface, the channels configured to transport liquid from the inlet surface through the heating body by capillary action;
wherein the heating body comprises electrically conductive material and the evaporator further comprises circuitry for providing a current through the electrically conductive material to provide resistive heating of the heating body to evaporate a liquid passing through the channels;
wherein the heating body and circuitry are configured to provide a positive temperature gradient across the heating body from the inlet surface to the outlet surface.

2. The evaporator of claim 1 wherein the heating body comprises one or more layers of electrically conductive material arranged to provide the positive temperature gradient across the heating body.

3. The evaporator of claim 1 wherein the electronically conductive material is arranged as a resistive heating layer at the outlet surface.

4. The evaporator of claim 1 wherein resistivity of the heating body varies across the heating body to provide the temperature gradient when a current is provided to the heating body.

5. The evaporator of claim 4 wherein the evaporator comprises a plurality of heating layers, wherein at least two of the plurality of heating layers have a different resistivity.

6. The evaporator of claim 1 wherein the heating body comprises a semiconductor or ceramic wherein the dopant concentration is configured to provide the positive temperature gradient when a current is provided to the heating body.

7. The evaporator of claim 6 wherein the heating body comprises a layer of increased dopant concentration at the outlet surface.

8. The evaporator of claim 1 wherein the heating body comprises a plurality of heating layers arranged sequentially between the inlet surface and the outlet surface; wherein the heating layers are heated to different temperatures to provide the temperature gradient.

9. The evaporator of claim 8 wherein the heating layers comprise a semiconductor material where the dopant concentration differs between the plurality of heating layers.

10. The evaporator of claim 8 comprising a layer of insulation between two neighbouring heating layers.

11. The evaporator of claim 1 wherein a diameter of one or more channels of the heating body decreases in a direction between the inlet surface and the outlet surface.

12. The evaporator of claim 1 wherein the temperature gradient is configured such that a liquid passing through the channels evaporates closer to the outlet surface than the inlet surface.

13. The evaporator of claim 1 wherein the evaporator is configured to provide a temperature at the inlet surface of 40° C. or more and a temperature at the outlet surface of between 200° C. and 350° C.

14. The evaporator of claim 1 further comprising a liquid store in fluid communication with the inlet surface of the heating body such that liquid is drawn from the liquid store through the heating body during use.

15. The evaporator of claim 1 wherein a diameter of the channels is between 5 μm and 200 μm.
